(19) United States
(12) Patent Application Publication
(10) Pub. No.: US 2016/0250593 A1
(43) Pub. Date: Sep. 1, 2016

(54) AFTERTREATMENT ASSEMBLY

(71) Applicant: Caterpillar Inc., Peoria, IL (US)

(72) Inventors: Kevin J. Weiss, Peoria, IL (US); Chiranjeevi Mangamuri, Peoria, IL (US); Scott M. Peters, Edwards, IL (US); Cory A. Brown, Peoria, IL (US); David A. Akers, Morton, IL (US)

(73) Assignee: Caterpillar Inc., Peoria, IL (US)

(21) Appl. No.: 15/149,380

(22) Filed: May 9, 2016

(51) Int. Cl. B01D 53/94; F01N 3/10; F01N 13/18; F01N 3/20

(52) U.S. Cl. CPC B01D 53/9431; F01N 3/2066; F01N 3/103; F01N 13/1827; F01N 2610/01; B01D 2251/2067

(57) ABSTRACT

An aftertreatment assembly is disclosed. The aftertreatment assembly includes a housing including an inlet and an outlet. A chamber is disposed downstream of the inlet, and is axially to the inlet. At least one bank of catalyst module is disposed downstream of the chamber, and is extending laterally from the chamber. A plenum is disposed over the chamber, and is extending laterally from the at least one bank of catalyst module. At least one first sealing member is disposed between the at least one bank of catalyst module and the chamber and the plenum. The at least one first sealing member having a first portion and a second portion between the plenum and the chamber.

### TECHNICAL FIELD

The present disclosure relates to an aftertreatment assembly, and more specifically, to a modular aftertreatment assembly with a plenum.

### BACKGROUND

An exhaust gas aftertreatment system is used to reduce various harmful pollutants, such as Carbon Monoxide (CO), and different oxides of nitrogen such as Nitric Oxide (NO), or Nitrogen Dioxide (NO₂) present in exhaust gases of engines. The exhaust gas aftertreatment system converts such harmful gases into non harmful gases, such as, but not limited to, NOx into Nitrogen (N₂) and water (H2O).

Currently, the exhaust gas aftertreatment system includes various components such as, but not limited to, dual NOx sensors equivalent outlets, a mixing chamber, a plenum, and catalyst banks. However, this arrangement has resulted in degrading performance of the aftertreatment system. For example, the dual NOx sensors equivalent outlets result in increased cost of production. Also, at times, the catalyst banks require regular maintenance to maintain proper functioning of the aftertreatment system. The catalyst banks are typically accessed and serviced from an upper portion which requires the plenum to be removed and reinstalled. Further, the aftertreatment system having a separate plenum which is very bulky and is very expensive. Therefore, there is a need for an improved aftertreatment system which is cost effective, and enhances the performance of the aftertreatment system.

German patent number DE102010027293 discloses an exhaust gas treatment system. The exhaust gas treatment system discloses a housing having an exhaust gas inlet and an exhaust outlet. The housing includes an insert in which exhaust gas elements such as particulate filters, oxidation catalysts, or NOx catalysts are provided. The housing further includes a closeable opening for introducing and removing the insert together with the exhaust gas treatment elements. The reference further discloses a seal which is provided between a flange and the housing, and between the flange and lid, so that the exhaust gas treatment unit is sealed gas-tight. However, such type of the design of the exhaust gas aftertreatment system is not compact and robust. Therefore, there is a need for a design which is more compact and robust.

### SUMMARY OF THE DISCLOSURE

In one aspect of the present disclosure, an aftertreatment assembly is provided. The aftertreatment assembly includes a housing. The housing includes an inlet and an outlet. A chamber is disposed downstream of the inlet, and axially to the inlet. At least one bank of catalyst module is disposed downstream of the chamber, and is extending laterally from the chamber. A plenum is disposed over the chamber, and is extending laterally from the at least one bank of catalyst module. At least one first sealing member is disposed between the at least one bank of catalyst module and the chamber and the plenum. The at least one first sealing member having a first portion and a second portion between the plenum and the chamber.

Other features and aspects of this disclosure will be apparent from the following description and the accompanying drawings.

### BRIEF DESCRIPTION OF THE DRAWINGS

FIG. 1 is a perspective view of an aftertreatment assembly, in accordance with the concepts of the present disclosure;

FIG. 2 is an exploded view of the aftertreatment assembly of FIG. 1, in accordance with the concepts of the present disclosure;

FIG. 3 is a cross sectional view of the aftertreatment assembly taken along 3-3′ of FIG. 1 showing a chamber, at least one bank of catalyst module, and a plenum, in accordance with the concepts of the present disclosure;

FIG. 4 is a perspective view of the aftertreatment assembly showing a cover, the at least one bank of catalyst module, at least one first sealing member, and a second sealing member, in accordance with the concepts of the present disclosure; and

FIG. 5 is a schematic diagram of the aftertreatment assembly showing the at least one bank of catalyst module, the at least one first sealing member, the second sealing member, the plenum and the flow path of the exhaust gas, in accordance with the concepts of the present disclosure.

### DETAILED DESCRIPTION

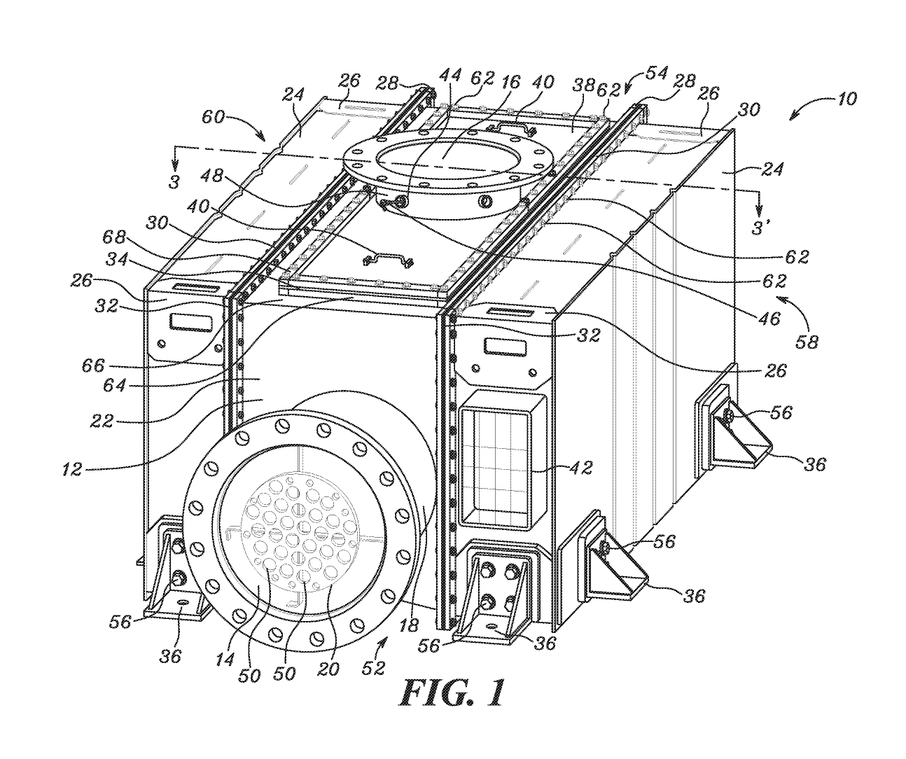

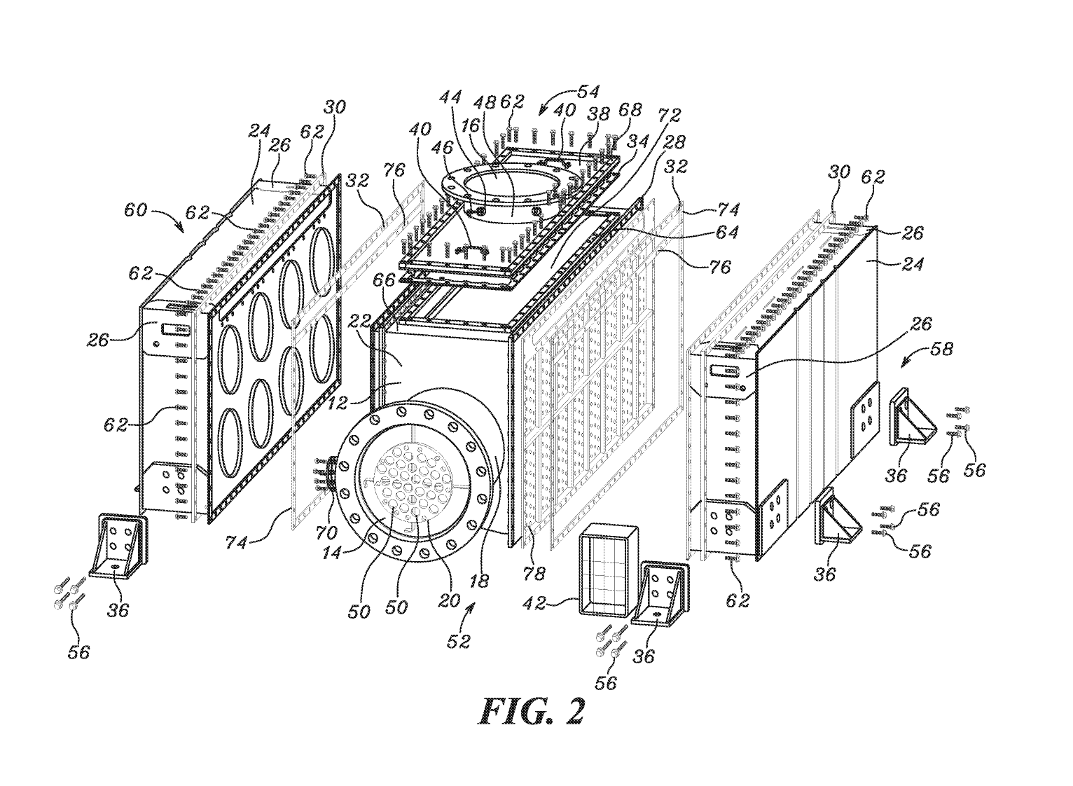

Referring to FIGS. 1 and 2, an aftertreatment assembly 10 includes a housing 12 including an inlet 14 and an outlet 16, a first conduit 18, a first plate 20, a chamber 22, at least one bank of catalyst module 24, a number of plates 26, a number of first bars 28, a number of second bars 30, at least one first sealing member 32, a second sealing member 34, brackets 36, a cover 38 having a pair of handles 40, a sensor box 42, a NOx flute 44, a NOx sensor 46, a second conduit 48, an injector nozzle 70 (shown in FIG. 2), and a plenum 72 (shown in FIG. 2). The aftertreatment assembly 10 may be used in a variety of applications such as locomotives, marine applications, or power generators. It should be noted that the aftertreatment assembly 10 may be used in machines such as, but not limited to, a hydraulic excavator, or a track-type tractor. The aftertreatment assembly 10 further includes various other components such as, but not limited to, an electrical connector. For the purpose of simplicity, various other components of the aftertreatment assembly 10 are not labeled in FIG. 1. It will be apparent to one skilled in art that the aftertreatment assembly 10 shown in FIG. 1 is a SCR catalyst system, however, the aftertreatment assembly 10 may include any other type of aftertreatment assembly such as diesel oxidation catalysts or DPFs.

The exhaust gases enter through the inlet 14, and flow through the first conduit 18. The first conduit 18 is adapted to define a passage along a length of the first conduit 18 for the exhaust gases to flow therethrough. Further, the first plate 20 is disposed downstream of the inlet 14, and is coupled to the first conduit 18. The first plate 20 further includes a plurality of holes 50 to allow the exhaust gases to pass through. The first plate 20 is adapted to lower velocity of the exhaust gases flowing through the first conduit 18. This introduces a low velocity zone at a point of urea injection allowing for a larger spray cone, and improved mixing of the exhaust gases with an aqueous solution of urea, which is injected through the injector nozzle 70 (shown in FIG. 2).

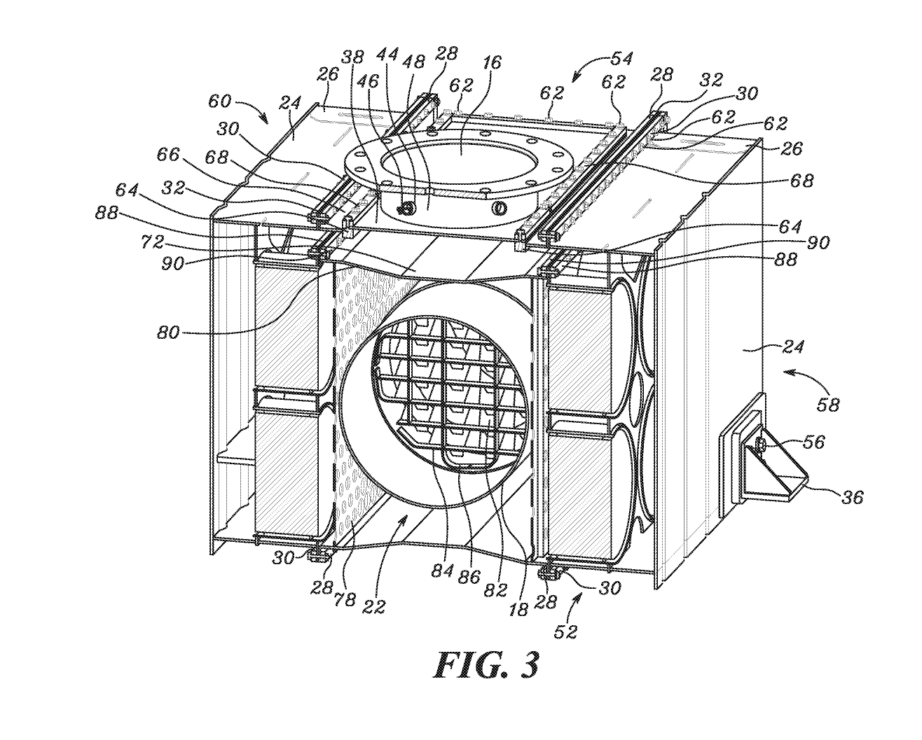

Referring to FIGS. 2 and 3, the first conduit 18 includes a mixer 82 (shown in FIG. 3) which is disposed in a direction perpendicular to the length of the first conduit 18. The mixer 82 includes a number of first bars 84 coupled to a number of second bars 86. The first bars 84 and the second bars 86 are arranged perpendicular to each other. The mixer 82 is adapted to uniformly mix the aqueous solution of urea with the exhaust gases. The chamber 22 is disposed axially to the inlet 14, and is in fluid communication with the first conduit 18. The at least one bank of catalyst module 24 extends laterally from the chamber 22, and is in fluid communication with the chamber 22. As an example, the at least one bank of catalyst module 24 is a selective catalyst reduction module. It should be noted that the at least one bank of catalyst module 24 is disposed on both sides of the chamber 22. Further, the at least one bank of catalyst module 24 is adapted to convert harmful nitric oxide (NO) or nitrogen dioxide (NO₂), and ammonia (NH₃) into nitrogen and water.

The at least one bank of catalyst module 24 is further provided with the plates 26. The plates 26 are coupled with the at least one bank of catalyst module 24 at corners (i.e., top corners) of a first side 52 and a second side 54 of the aftertreatment assembly 10. The plates 26 are utilized to lift the at least one bank of catalyst module 24. Further, the at least one bank of catalyst module 24 is coupled with the brackets 36 using first fasteners 56 on the first side 52, the second side 54, a third side 58, and a fourth side 60 of the aftertreatment assembly 10. The at least one bank of catalyst module 24 is coupled to the plenum 72 and the chamber 22 by fastening the first bars 28 and the second bars 30 using second fasteners 62. It will be apparent to one skilled in art that although six brackets are shown in the current example, one or more brackets 36 may not be required for every installation of the aftertreatment assembly 10.

Further, the at least one first sealing member 32 is also disposed between the chamber 22 and the at least one bank of catalyst module 24 and the plenum 72. The at least one first sealing member 32 includes a first portion 74 (i.e., a circumferential portion) and a second portion 76 (i.e., a spanning potion). The first portion 74 is adapted to seal the joint between the first bars 28 and the second bars 30, and the second portion 76 is adapted to seal the joint between fifth bars 88 and sixth bars 90. As an example, the at least one first sealing member 32 is a removable sealable joint.

Further, the plenum 72 extends laterally from the at least one bank of catalyst module 24. The plenum 72 includes a second plate 80 which may have a bent profile. The bent profile of the second plate 80 provides a greater volume inside the plenum 72 to allow the exhaust gases to freely flow into the plenum 72, and from the plenum 72 into the outlet 16. Further, the fifth bars 88 and the sixth bars 90 couple the second plate 80 with the at least one bank of catalyst module 24, using the second fasteners 62. The aftertreatment assembly 10 further includes a perforated sheet 78 disposed between the chamber 22 and the at least one bank of catalyst module 24. The perforated sheet 78 is adapted to evenly distribute mass flow of exhaust gases within each one of the at least one bank of catalyst module 24.

The cover 38 is coupled to the plenum 72 by fastening third bars 64 and fourth bars 68 using the second fasteners 62. The third bars 64 (shown in FIG. 2) are welded to a first surface 66 of the chamber 22 to assist with the aftertreatment assembly 10 of the second fasteners 62. The second sealing member 34 is further disposed between the third bars 64 and the fourth bars 68. The second sealing member 34 is adapted to prevent leak from the joint between the cover 38 and the plenum 72. As an example, the second sealing member 34 is a removable sealable joint. The cover 38 is provided with the pair of handles 40 which are utilized to lift up the cover 38 for various operations such as, but not limited to, servicing operations, or changing components of the aftertreatment assembly 10. The cover 38 is coupled to the second conduit 48, which is fluidly connected to the plenum 72. The second conduit 48 includes a flanged connection to facilitate connection with an exhaust pipe (not shown). The second conduit 48 further includes the NOx flute 44 for mounting the NOx sensor 46. The NOx sensor 46 is mounted through the NOx flute 44, and is adapted to detect NOx content present in the exhaust gases, flowing out from the outlet 16.

It should be noted that the aftertreatment assembly 10 further includes the sensor box 42 which is disposed at the first side 52 of the at least one bank of catalyst module 24. The sensor box 42 is adapted to measure at least one of pressure of NOx content, temperature of the NOx content, or NOx concentration, representative of the exhaust gas. It will be apparent to one skilled in the art that the aftertreatment assembly 10 mentioned above are made from various materials such as, but not limited to, stainless steel, cast iron, varying grades of steel, aluminum, grey, or ductile iron, without departing from the scope of the disclosure.

### INDUSTRIAL APPLICABILITY

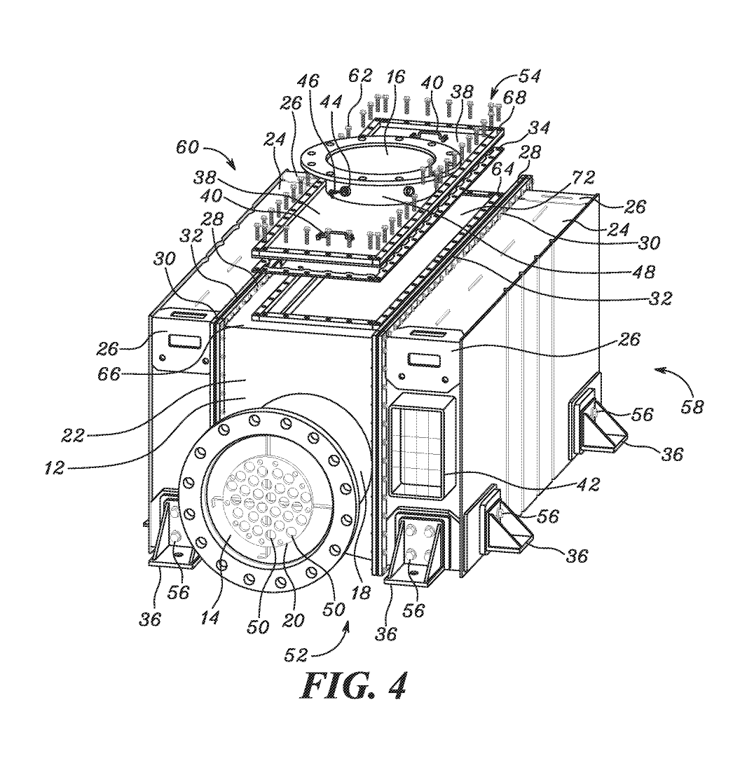

Referring to FIG. 4, the handles 40 of the cover 38 are utilized to lift up the cover 38 in order to perform various servicing operations. For example, in order to perform the servicing operations, the second fasteners 62 are removed, and the cover 38 is lifted using the handles 40. This in turn provides access to the coupling between the fifth bars 88 and the sixth bars 90 for servicing.

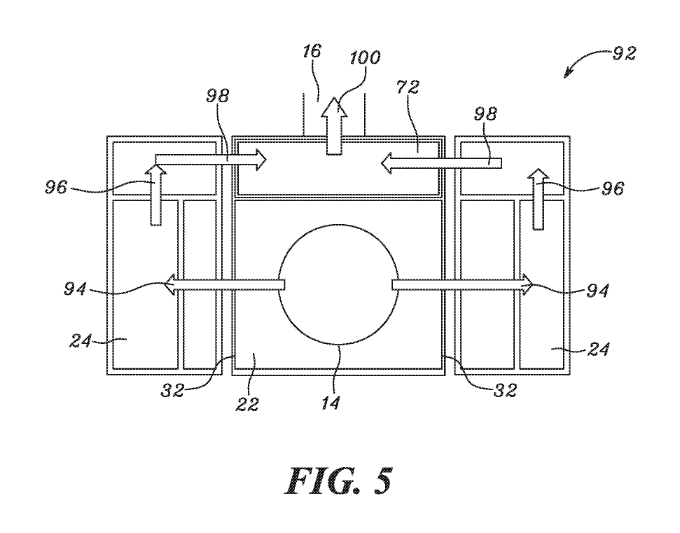

Referring to FIG. 5, a schematic diagram 92 of the aftertreatment assembly 10 discloses that the exhaust gases enter through the inlet 14, and then flow through the first conduit 18 (shown in FIG. 3). After passing through the first conduit 18, the exhaust gases then flow into the chamber 22. The chamber 22 is in fluid communication with the at least one bank of catalyst module 24. The exhaust gases then flow into the at least one bank of catalyst module 24, as depicted by a first arrow 94. Thereafter, the exhaust gases flow towards top of the at least one bank of catalyst module 24, as depicted by a second arrow 96. After passing through the at least one bank of catalyst module 24, the exhaust gases flow from the top of the at least one bank of catalyst module 24 towards the plenum 72, which is depicted by a third arrow 98. Thereafter, the exhaust gases are expelled from the aftertreatment assembly 10 through the outlet 16, which is depicted by a fourth arrow 100. The first portion 74 (shown in FIG. 2) of the at least one first sealing member 32 prevents exhaust gases containing harmful pollutants (such as nitric oxide (NO)) from leaking into the atmosphere. Similarly, the second portion 76 prevents (shown in FIG. 2) prevents exhaust gases containing harmful pollutants (such as nitric oxide (NO)) from leaking internally into the plenum 72 of the aftertreatment assembly 10. Similarly, the second sealing member 34 (shown in FIG. 2) is disposed between the third bars 64 (shown in FIG. 2) and the fourth bars 68 (shown in FIG. 2), to prevent leak from the joint between the cover 38 (shown. in FIG. 2) and the plenum 72.

Referring to FIGS. 2 and 3, the present disclosure provides the aftertreatment assembly 10. The aftertreatment assembly 10 includes the chamber 22, which improves the proper mixing of the aqueous solution of urea into the exhaust gases. Further, the plenum 72 is disposed within the aftertreatment assembly 10, which makes the design of the aftertreatment assembly 10 compact and robust. Further, the aftertreatment assembly 10 improves mixing of the NOx content in the exhaust gases due to longer distance from the at least one bank of catalyst module 24 to the outlet 16. Also, the aftertreatment assembly 10 includes a single NOx sensor 46, which reduces initial cost of production and operation, The quality risk is also minimized by using a single NOx sensor. Further, the aftertreatment assembly 10 improves durability by minimizing the number of components of the aftertreatment assembly 10 that require regular maintenance, or may have failures. Further, the aftertreatment assembly 10 reduces backpressure by increasing size of the second conduit 48. Thus, such type of the aftertreatment assembly 10 is compact, easily serviceable, free from leaks, and enhances the performance of the aftertreatment assembly 10. The compact structure of the aftertreatment assembly 10 provides for easy fitment of the aftertreatment assembly 10 in a variety of different applications, such as such as locomotive, marine applications, or power generators. The assembling and labor costs for the aftertreatment assembly 10 at the time of production are also reduced, due to reduction in welding requirements and laser cutting.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof

What is claimed is:

1. An aftertreatment assembly comprising:
a housing including an inlet and an outlet;
a chamber disposed downstream of the inlet, and axially to the inlet;
at least one bank of catalyst module disposed downstream of the chamber, and extending laterally from the chamber;
a plenum disposed over the chamber, and extending laterally from the at least one bank of catalyst module; and
at least one first sealing member disposed between the at least one bank of catalyst module and the chamber and the plenum, the at least one first sealing member having a first portion and a second portion between the plenum and the chamber.

2. The aftertreatment assembly of claim 1, wherein the chamber is adapted to mix urea into exhaust gases.

3. The aftertreatment assembly of claim 1 further including a second sealing member disposed over the plenum, and a cover disposed over the second sealing member.
